(19) United States
(12) Patent Application Publication
(10) Pub. No.: US 2007/0017558 A1
(43) Pub. Date: Jan. 25, 2007

(54) Surface cleaner with multiple angled orifices

(76) Inventor: Charles A. Walton, Los Gatos, CA (US)

Correspondence Address: Charles A. Walton, 19115 Overlook Road, Los Gatos, CA, 95030, US

(21) Appl. No.: 11/184,425

(22) Filed: Jul. 20, 2005

(51) Int. Cl. B08B 3/00; B08B 3/12

(52) U.S. Cl. 134/109; 134/184; 134/198; 134/110

(57) ABSTRACT

A system that cleans boat bottoms, or aquarium windows, and also stimulates the skin, yet does not penetrate or break the skin. The cleaning or skin stimulation is accomplished by high speed high pressure liquid flow, through multiple orifices carried by an orifice plate, with all or most orifices positioned at preselected angles, rather than simply perpendicular or parallel. The angle positioning emits water or fluids in a tangential manner to cause flow in a circle or straight line. The multiple orifices cooperate and force the water in the same direction, so that the cleaning effect is greater than that of individual perpendicular flow. An inner shroud around the head briefly captures much of the water. The water is largely caught by a second outer shroud and returned to the pump. The return water flow creates a suction and force on the head towards the surface to be cleaned. Filters before and after the pump remove the debris from the water. The system is also suited to hot tubs, private or public, for refreshing bathing.

### BACKGROUND

Surfaces pickup various undesired contaminants. One type is that which settles from impurities in the air. Another is biological aqueous growth, such as algae, fungus, or mold. These undesired contaminants can be removed with brushing, scrubbing, high pressure liquid, and/or chemical solvents. Removing the contaminants often needs mechanical power such as brushes or high speed sprays. Remaining, or used water, exits from the vicinity of the head.

Typical jet cleaners use straight on streams, to flush debris away from the surface. The individual jets do not add their forces. The residual water will, in an aquarium, stir up much sedimentary debris, and leave the water after the cleaning more turbid than before.

### SUMMARY DESCRIPTION

A system that cleans boat bottoms, or aquarium windows, and also stimulates the skin, yet does not penetrate or break the skin. The cleaning or skin stimulation is accomplished by high speed high pressure liquid flow, through multiple orifices, with all or most orifices positioned at preselected angles, rather than simply perpendicular or parallel. The nozzles are set to strike at an angle and liquid strikes the surface tangentially. The angle strike improves the cleaning effectiveness, and better carries away the contamination.

Adjoining nozzles are arranged so that their streams add power to one another. By arranging the nozzles pointing in a circular direction, a circular flow of water is established. The multiple nozzles sum their forces so that more effective cleaning is obtained.

The angle positioning emits water or fluids in an angular manner to cause additive rates of flow, in a circle or straight line. The angle is greater than zero degrees, and less than ninety degrees, and is typically 45 degrees. The liquid strikes with a glancing flow, causing stimulation and scrubbing with out injuring the skin or the surface.

An inner shroud around the head briefly captures much of the water. The water exits the shroud either under or through side orifices. The water is largely caught by a second outer shroud and returned to the pump. The return water flow creates a suction force on the head towards the surface to be cleaned and there is consequently less need for the operator to push the head toward the surface. Filters before and after the pump remove the debris from the water and make the ambient water cleaner.

It is the purpose of this invention to remove contaminants quickly and completely from a surface with minimum effort. The device is suited to hot tubs, private or public, for refreshing bathing and for speedier recovery from some muscle problems, and for removing algae and contamination from an underwater surface. Filters in the water flow catch much of the debris and thus clean the waste water.

### LIST OF FIGURES

FIG. 1 shows the basic assembly, comprised of nozzle head, housing, pump, fluid return, with bellows to control the water flow and adapt to uneven bottom contours.

FIG. 2 shows the nozzle head portions of the system.

FIG. 3 shows one form of the nozzle plate, comprised of a plate with multiple small nozzles.

FIG. 4 show a version suitable for stimulating the skin, with a telescoping intermediate bell, to prevent dispersing the water widely when not in use against the skin or other surface. FIG. 4 also shows an automatic valve to halt water flow when not wanted

### DETAILED DESCRIPTION

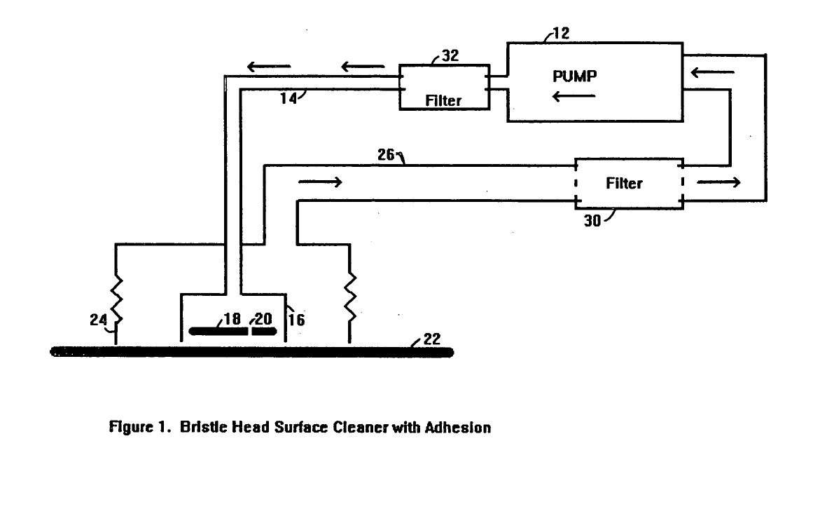

Refer first to FIG. 1. There is a pump 12, pumping a fluid, typically water, through flexible pipe 14, and down (usually below) water level to a bellows or bell 16. The bell 16 is also referred to as the inner shroud. At the bottom of the bell 16 is a nozzle plate 18, also referred to as an orifice plate, bearing numerous small holes or nozzles 20, out of which the water exits, to strike the surface 22 to be cleaned. The nozzle plate 18 is also described as a bristle head when the orifices 20 are aligned to produce rotary flow. The water then exits from beneath the orifice plate 18 and under bell 16. Nozzle plate 18 is supported by screws 21A and 21B from bell 16.

Not shown are additional plate supporting crews 21C and 21D, perpendicularly placed with regard to supporting crews 21A and 21B

Surrounding the bell 16 is another larger bell 24, also referred to as the outer shroud 24. Much of the exit water is picked up by bell 24 and exits via flexible pipe 26. There is suction on bellows 24. Flexible pipe 26 returns the water to the input of pump 12. Debris is constantly removed from the circulating system by one or both filters 30 and 32.

Bell 16 controls the flow towards the surface 22 and bell 24 controls the flow back to the pump 12. Bells 16 and 24 are given flexible perimeters so that they also act as bellows, and can thus conform to tilt and irregularities on the surface 22, to better confine the flow, and to minimize irregular and undesired water flow, and to minimize any tendency to spread debris throughout the main body of the water. The surface 22 may be the sides and bottom of a boat, or may be the sides of an aquarium, or may be a deck of any kind which needs cleaning, or the surface 22 may be the skin or fur of an animal or human skin which needs stimulation and cleaning.

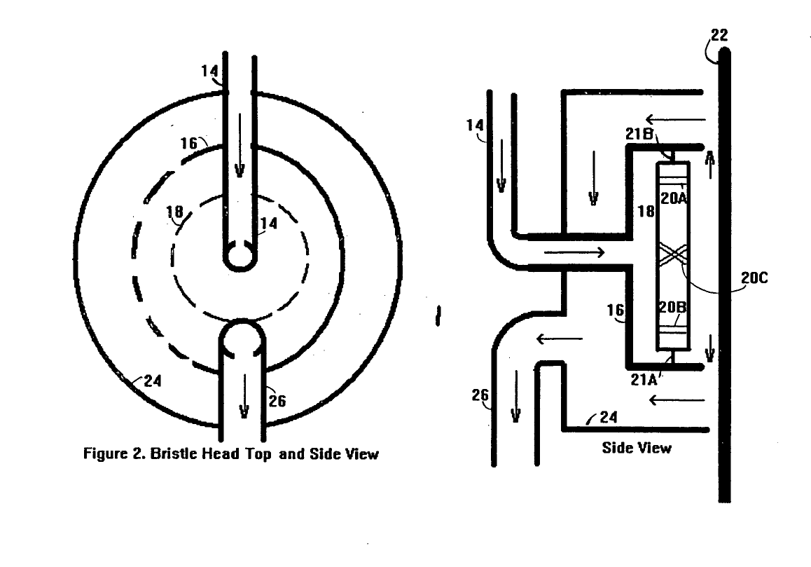

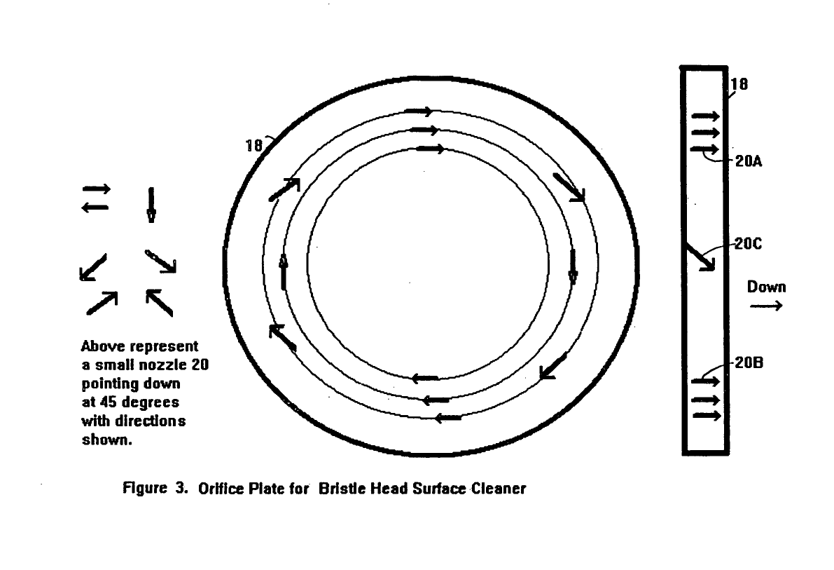

Refer next to FIG. 2. FIG. 2 shows a larger view of the cleaning head of the system. The nozzle plate 18 and the surface 22 are shown vertical. Water enters from the pump 12 via pipe 14. It passes through to bell 16 and then through the orifice plate 18 using holes 20A, 20B, 20C, etc. In practice there are multiple holes 20, as indicated in FIG. 3. The water exits from under bell 16 to bell 24 and then from pipe 26 back to pump 12.

The bellows 16 and 24 are made with adjustable sides, to guide the water, regardless of irregularities in the surface. The bellows in general conform to the surface 22. The return flow to pump 12 through bellows 24 is by suction, and this suction aids in providing pressure of the orifice plate 18 against the surface 22.

In FIG. 3 the orifice plate 18 is shown in more detail. It is a circular disc although it could be rectangular. The material is typically aluminum, plastic, or rubber. There are multiple orifices 20, all of which encourage the water under the plate 18 to rotate, clockwise or counterclockwise, with clockwise illustrated. The orifices 20 may also be arranged to encourage a linear flow from one edge to the other. Each jet nozzle squirts in water, at a glancing angle, both against the surface 22 and in the rotary manner, clockwise as indicated.

The skirt of bell 16 urges the water to stay confined and to pick up rotary speed. The speed adds up under each jet and thus ends up with better scrubbing of the surface 22 than is the case when just a direct-on orifice is used. Similarly, the glancing action of a tilted orifice is kinder to the human skin than is direct impact, and is less likely to tear the skin.

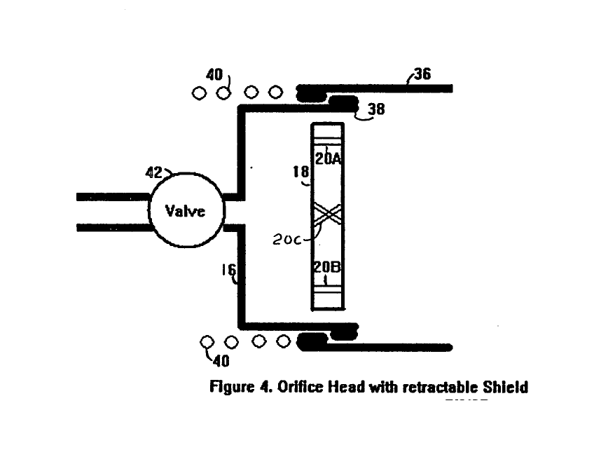

In FIG. 4 is shown a variation to make skin stimulation easy and simple. In the Scandinavian countries it is popular to smack the skin with sticks while in a hot tub or spa. A set of slender water beams from a nozzle can accomplish a similar effect. Simple direct in-line nozzles have the disadvantages of sending water all over the place, and direct nozzles can create or open holes in the skin. Both these disadvantages are overcome in FIG. 4. The nozzles 20 in orifice plate 18 are tilted and thus avoid direct force on the skin. Also, there is an additional shroud 36 to catch water going sideways. The shroud 36 is withdrawn in use by allowing it to slide back over the walls of 16. Spring 40 returns the shroud 36 when use is ended. A second way to stop surplus water it to use valve 42, which is opened when needed and closed when not, using any suitable linkage (usually linked to the body), not shown.

Variations not Shown:

The water return area can be in the center of the spray head, instead of around the perimeter of the nozzle area. The bristle nozzles could be arranged to rotate CW at the center and CCW at the perimeter, thus avoiding the torque on the head produced by all pointing in the same direction of rotation. The nozzles could be arranged to all point in the same direction, rather than in a rotary manner. The exhaust waste could be sent to a disposal area, and not recirculated around, thus keeping the water less loaded with debris or algae.

1. A system for surface cleaning, comprising an output nozzle, a motorized pump to supply water or other liquids to the nozzle, and a water supply to the pump.

2. A system for surface cleaning, as in claim 1, in which the said water supply is from a housing which surrounds and collects water from the nozzle.

3. A system for surface cleaning, as in claim 2, in which said housing is a dome which collects water from the dome around the nozzle.

4. A system for surface cleaning, as in claim 1, in which said output nozzle is formed of a series of small holes drilled through a nozzle plate at the end of the hose from the pump, wherein these small holes concentrate the fluid flow, to achieve high local pressure and high impact force of fluid against the surface.

5. A system for surface cleaning, as in claim 4 in which said nozzle holes run between the two nozzle plate major surfaces at an angle, typically between 10 and 80 degrees away from the vertical.

6. A system for surface cleaning, as in claim 5, in which said nozzle holes are arranged to propel the water not only against the surface, but also with a cooperating sideways propulsion component, and the sideways component is selected to propel the water in an additive circular direction under the nozzles, thus increasing the overall power of the water flow, and pushing the surface contamination and soil in the direction of the nozzles as well as scrubbing it away from the surface.

7. A system for surface cleaning, as in claim 6, in which said circular propulsion causes accumulative added propulsion of the water in a circle, thus creating added cleaning power.

8. A system for surface cleaning, as in claim 2, in which water being drawn from said outer housing causes suction of the head against the surface, the suction causing the head to press against the surface, thus increasing the impact of the water from the nozzles against the surface, and increasing the quality of the cleaning.

9. A system for surface cleaning as in claim 1, further comprising a filter between return intake and the pump to capture algae and dirt

10. A system for surface cleaning as in claim 1, further comprising a filter between pump outlet and the nozzle to further capture algae and dirt.
